(19) United States
(12) Patent Application Publication
(10) Pub. No.: US 2012/0290990 A1
(43) Pub. Date: Nov. 15, 2012

(54) Pattern Measuring Condition Setting Device

(75) Inventors: Yasutaka Toyoda, Mito (JP); Ryoichi Matsuoka, Yotsukaido (JP)

(73) Assignee: Hitachi High-Technologies Corporation, Tokyo (JP)

(21) Appl. No.: 13/519,356

(22) PCT Filed: Dec. 1, 2010
(86) PCT No.: PCT/JP2010/006998

§ 371 Date: Jun. 27, 2012

(30) Foreign Application Priority Data
Dec. 25, 2009 (JP) 2009-296661

(51) Int. Cl. G06F 17/50

(52) U.S. Cl. 716/52

(57) ABSTRACT

When setting a measurement position, on the basis of a defect coordinate, on a sample, which is arranged with a complex pattern or a plurality of patterns and which has a pattern in which the influence of the optical proximity effect needs to be evaluated, the measurement position is set so as to improve work efficiency. Provided is a device for setting a first measurement position and a second measurement position, wherein: a reference line comprising a plurality of line segments is superimposed on a two-dimensional region set by a pattern layout data; the first measurement position is set on the inside of a contour which indicates a pattern in which a defect coordinate on the layout data exists, and between the intersecting points of the reference line and said contour; and a second measurement position is set outside of said contour, and either on said contour and another portion of said contour or between the intersecting points of said contour and another portion of said contour.

### TECHNICAL FIELD

The present invention relates to a device for setting measuring conditions for a semiconductor device, and particularly to a device for setting conditions for measuring a reticle pattern on the basis of the result of wafer pattern inspection.

### BACKGROUND ART

In recent years, semiconductor devices have been manufactured with increasingly higher integration densities for the purposes of enhancing their performance and reducing the manufacture cost. To realize high-density integration of semiconductor devices, advances in lithography techniques for forming a fine circuit pattern on a wafer are necessary. Lithography is a process of producing a mask as an original of a circuit pattern and using an exposing device to transfer the mask circuit pattern to a photosensitive light-accepting resin (hereinafter referred to as a resist) applied on a wafer. Improvements in exposure techniques and resist materials have maintained the trend to finer circuit patterns. Particularly, OPC (Optical Proximity Correction, a technique of adding geometries to reticle patterns in order to reduce the optical proximity effect occurring at the time of patterning) has become an essential technique for realizing fine circuit patterns. The shapes of reticle patterns are therefore becoming more and more complex over the years.

The increasing complexity of reticle patterns makes the production of reticle patterns difficult, so that defectively produced wafer patterns resulting from defectively produced reticle patterns are increasing. In order to prevent such defectively produced wafer patterns due to reticle patterns, measures have been taken such as estimating a defect position with a wafer transfer simulation device to measure a reticle pattern corresponding to the estimated defect coordinates with a CD-SEM (Critical Dimension-SEM), or measuring, with a CD-SEM, a reticle pattern corresponding to defect coordinates detected with a wafer inspecting device after producing a wafer.

For example, a patent literature 1 describes identifying the position of a reticle defect by converting detected wafer defect coordinates into reticle coordinate values using CAD data. A patent literature 2 describes generating, according to defect information, a measurement recipe that stores SEM measuring conditions.

### CITATION LIST

### Patent Literature

Patent Literature 1: JP-A-2006-512582 (corresponding to U.S. Pat. No. 6,882,745)

Patent Literature 2: JP-A-2009-071271 (corresponding to U.S. Patent Application Publication No. 2009/0052765)

### SUMMARY OF INVENTION

### Technical Problem

In lithography with a 32 nm half-pitch or subsequent narrower half-pitches, the problem with wafer manufacture due to the increasing circuit-pattern density is more serious. Consequently, application of unconventional patterning techniques is required. As candidate techniques, development of new lithography techniques such as SMO (Source Mask Optimization) and ILT (Inverse Lithography Technology) is currently in progress. SMO is a method of producing a fine pattern by optimizing the shape of illumination light and the shape of a mask used in exposure. MT is a method of producing a fine pattern using a reticle having reticle-pattern shapes mathematically determined from target wafer-pattern shapes by taking exposure conditions into account.

In both techniques, the wafer-pattern shapes, which are the final targets, are different from the reticle-pattern shapes. The differences in shape are expected to be larger than those at the time of applying OPC.

Thus, various manufacturing techniques have been attempted for finer semiconductor devices. Unfortunately, for measuring devices and inspecting devices for pattern measurement, no techniques have been sufficiently established for automatically determining measuring conditions for patterns formed with techniques such as those described above. To measure a defect portion with a device such as a CD-SEM, information on the coordinates of a possibly defective position may be computed or detected with a simulation device (which may hereinafter be referred to as a simulator) or an external defect inspecting device, and then the field of view of a device such as a CD-SEM may be positioned at the computed coordinates. However, measuring only the coordinate position does not allow a complex pattern shape to be sufficiently evaluated.

In other words, the approaches in the above two inter-apparatus cooperation modes (a simulation device and a CD-SEM, and an inspecting device and a CD-SEM) generally involve only inspecting a reticle-pattern coordinate position corresponding to wafer-pattern defect coordinates or estimated defect coordinates. Accordingly, the influence of the differences in shape between the wafer patterns and the reticle patterns, which are expected to further increase in future, may prevent accurate determination of the reticle-pattern measurement position corresponding to the wafer-pattern defect coordinates, resulting in failure in the measurement. The patent literatures 1 and 2 make no mention of the presence of evaluation candidates other than the defect coordinates.

In addition, the optical proximity effect that influences the formation of wafer patterns at the time of producing a wafer depends on the distances between and dimensions of pattern shapes close to each other. Accordingly, the cause of a defect on a reticle pattern may not be able to be determined by measuring only a reticle pattern corresponding to defect coordinates on a wafer pattern.

Although it is possible to manually set a reticle-pattern measurement position in a CD-SEM with reference to wafer defect coordinates, this involves the problem of lengthy setting operations and therefore a decreased work efficiency.

A pattern measuring condition setting device will be described below. An object of the pattern measuring condition setting device is, for a sample having a complex pattern or a plurality of patterns arranged thereon for which an influence of the optical proximity effect is to be evaluated, to set measurement positions on the basis of defect coordinates or the like while preventing a decrease in work efficiency.

### Solution to Problem

To achieve the above object, a device and the like will be proposed below. The device is a pattern measuring condition setting device for setting pattern measurement positions on the basis of defect coordinates, characterized by including an operating unit that superimposes reference lines including a plurality of line segments on a two-dimensional area defined on pattern layout data, and sets a first measurement position that is inside a contour indicating a pattern containing the defect coordinates on the layout data and that is between intersections of the contour and a reference line, and a second measurement position that is outside the contour and that is between intersections of the contour and a reference line or between an intersection of the contour and a reference line and an intersection of another contour and the reference line.

### Advantageous Effects of Invention

The above configuration can facilitate setting a measurement position at defect coordinates, as well as setting measurement positions at positions other than the defect coordinates where an optical proximity effect or the like is considered to influence pattern dimensions.

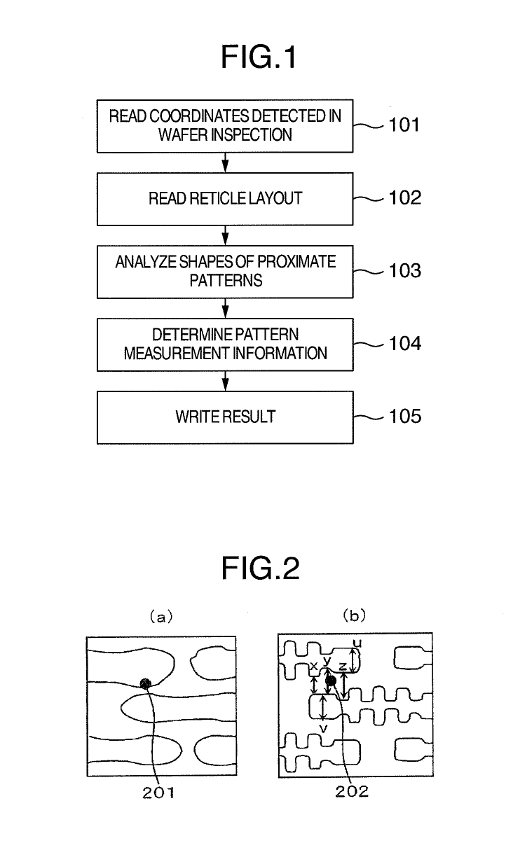

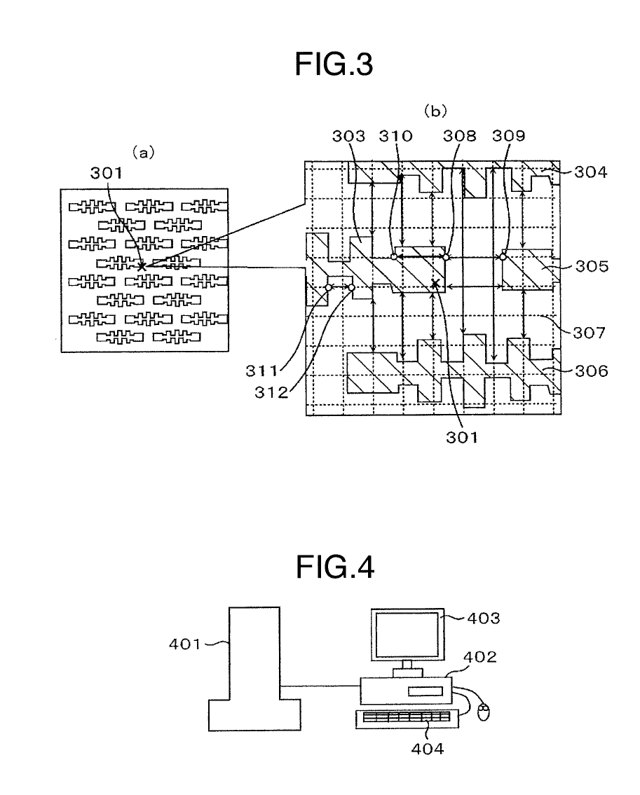

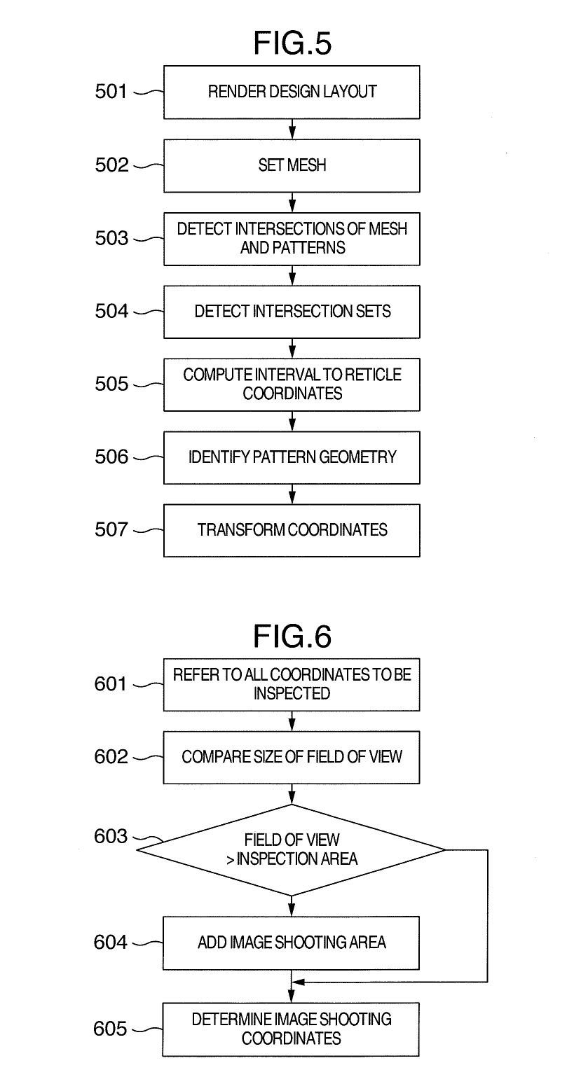

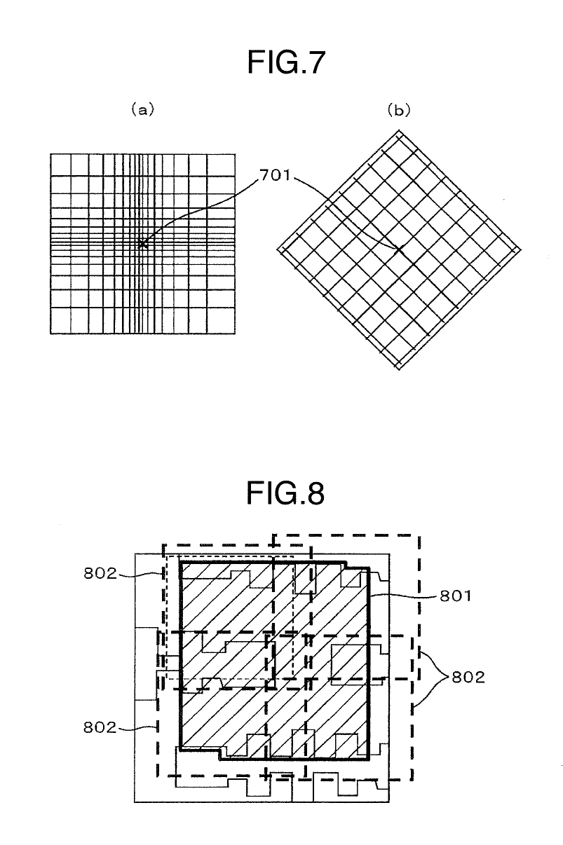

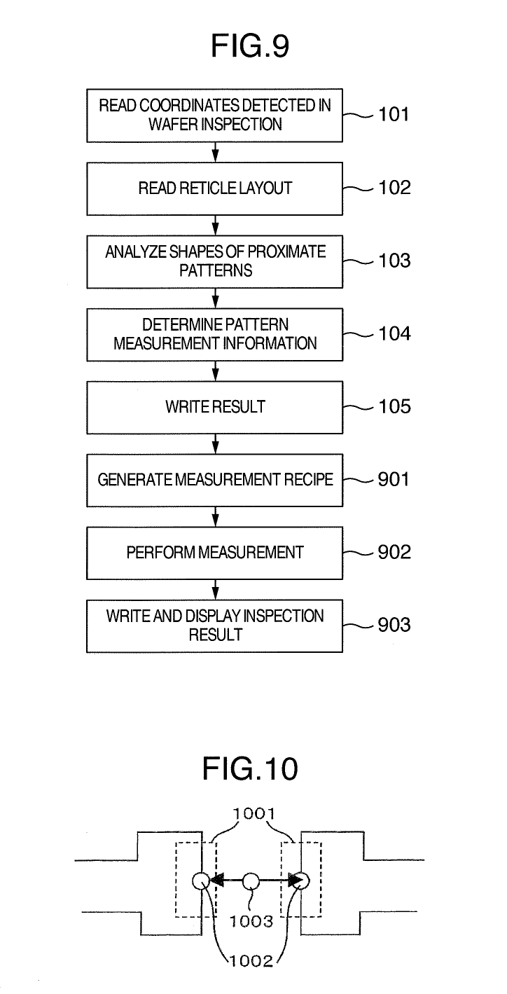

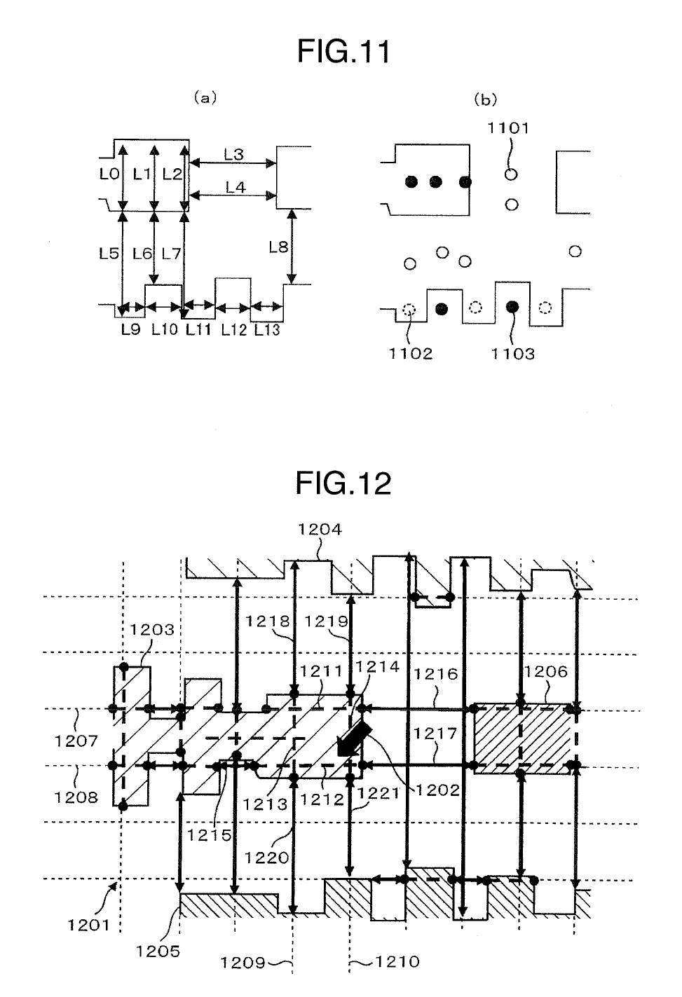

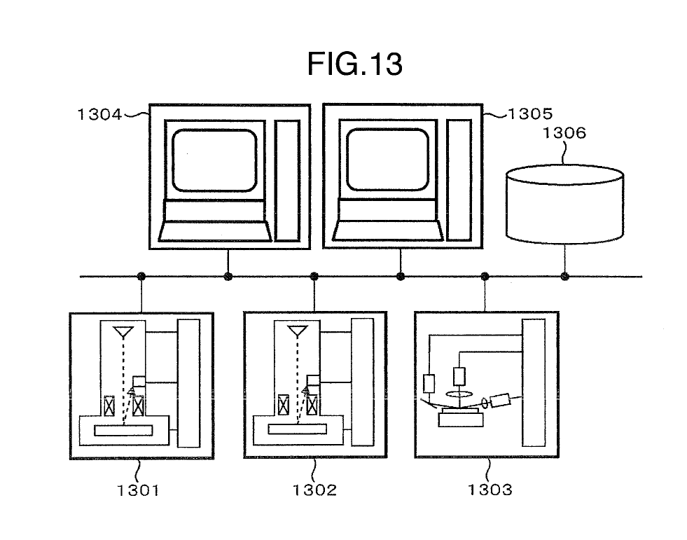

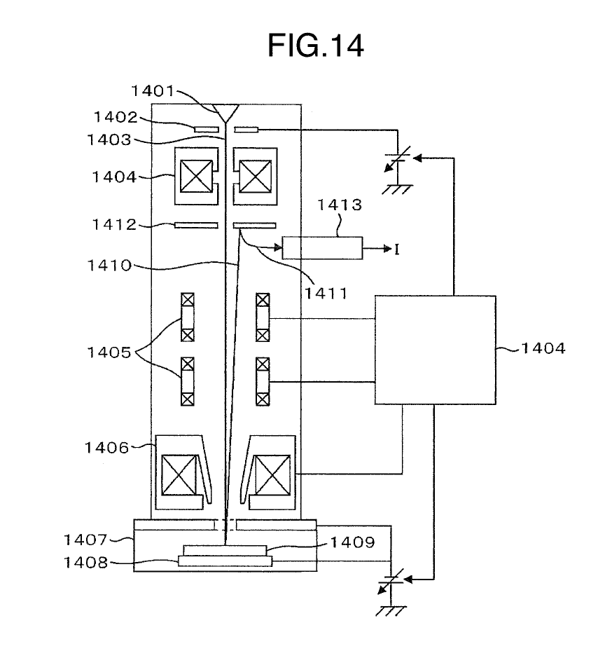

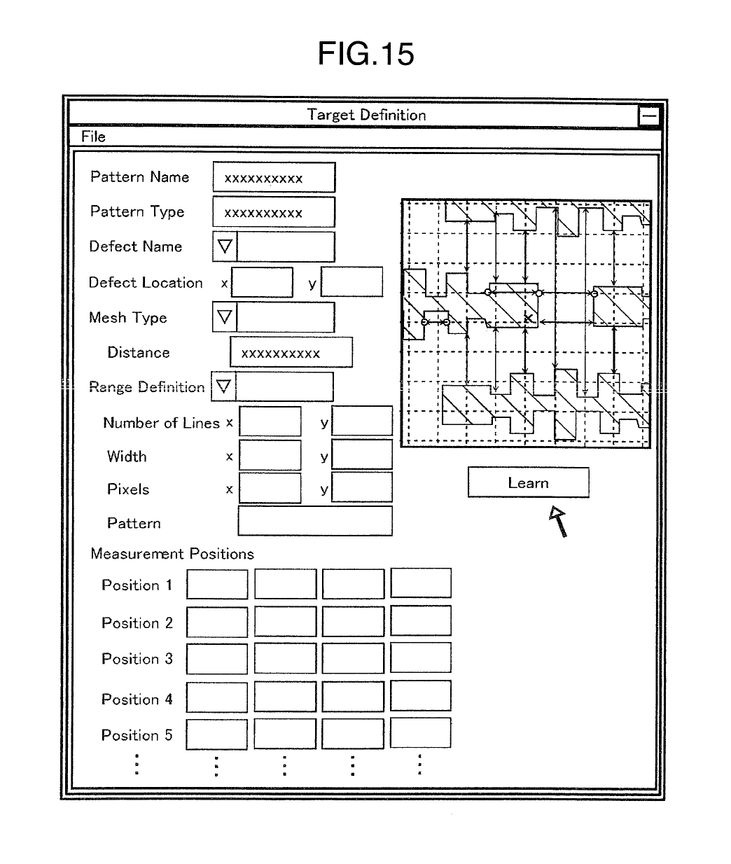

### BRIEF DESCRIPTION OF DRAWINGS

[FIG. 1] FIG. 1 is a flowchart describing a process of determining pattern measuring conditions on the basis of defect coordinate information.

[FIG. 2] FIG. 2 is diagrams illustrating wafer patterns and reticle patterns, as well as measurement positions on the reticle patterns.

[FIG. 3] FIG. 3 is diagrams describing a reticle-pattern design layout.

[FIG. 4] FIG. 4 is a diagram describing an exemplary pattern shape evaluating system.

[FIG. 5] FIG. 5 is a flowchart describing a process of analyzing shapes of proximate patterns.

[FIG. 6] FIG. 6 is a flowchart describing a procedure of dividing an image to be shot.

[FIG. 7] FIG. 7 is diagrams describing graphics (reference lines) used for proximate pattern analysis.

[FIG. 8] FIG. 8 is a diagram describing an example of how to divide an image.

[FIG. 9] FIG. 9 is a flowchart describing a process of generating a measurement recipe on the basis of read wafer coordinates and performing measurement according to the measurement recipe.

[FIG. 10] FIG. 10 is a diagram describing how a measurement point is set.

[FIG. 11] FIG. 11 are diagrams describing screens displaying measurement results.

[FIG. 12] FIG. 12 is a diagram describing an exemplary image in which defect coordinates, layout data, and a mesh of reference lines are superimposed.

[FIG. 13] FIG. 13 is a diagram describing an exemplary semiconductor measuring system.

[FIG. 14] FIG. 14 is a schematic diagram describing a scanning electron microscope.

[FIG. 15] FIG. 15 is a diagram describing an exemplary GUI screen for setting measuring conditions.

### DESCRIPTION OF EMBODIMENTS

In the section of Description of Embodiments, a measuring condition setting device will be described with reference to the drawings. The measuring condition setting device includes an operating unit that determines, mainly from information on reticle coordinates corresponding to defect coordinates on a wafer detected in inspection of the wafer or of a transferred image on the wafer and from information on a reticle design layout containing the reticle coordinates, measurement information for measuring a pattern having a reticle pattern edge most proximate to the reticle coordinates and also measurement information for measuring a pattern that is in a predetermined area containing the reticle coordinates and that does not have the most proximate reticle pattern edge. This device configuration allows automatically generating measurement information for comprehensively measuring reticle patterns that may have an influence at the time of producing a pattern determined as defective on the wafer.

With reference to the drawings, description will be given of a method, a device, a system, and a computer program (or a storage medium storing the computer program or a transmission medium transmitting the program) for determining measuring conditions based on the coordinates of a defect or a possibly defective site on a semiconductor wafer. More specifically, a device and a system that include a CD-SEM (Critical Dimension-Scanning Electron Microscope), which is a kind of measuring device will be described, and a computer program implemented in the device and the system will be described.

Although the description below illustrates a charged particle beam device as an image-forming device and describes the use of a SEM as an exemplary implementation of the device, this is not limiting. For example, an FIB (Focused Ion Beam) device that scans a sample with an ion beam to form an image may be employed as the charged particle beam device. However, since measurement of increasingly finer patterns with high accuracy requires an extremely high magnification, it is desirable to use a SEM, which is generally superior to an FIB device in terms of resolution.

FIG. 13 is a schematic diagram describing a measuring and inspecting system in which a plurality of measuring or inspecting devices are connected to a network. In this system, connected to the network are a CD-SEM 1301 that mainly measures pattern dimensions of a semiconductor wafer, photomask, or the like, a SEM-based defect inspecting device 1302 that irradiates a sample with an electron beam to output information about coordinates indicating where a defect is and about the size of the defect, and an optical inspecting device 1303 that irradiates the sample with light and detects reflected light from the sample to determine the coordinates and size of the defect. Also connected to the network are a condition setting device 1304 that sets measurement positions, measuring conditions, and the like on semiconductor device design data, a simulator 1305 that simulates the quality of patterns on the basis of the semiconductor device design data, manufacture conditions for semiconductor manufacturing devices, and the like, and a storage medium 1306 that stores design data in which layout data and manufacture conditions for the semiconductor device are registered.

The defect inspecting device 1302 may be a device such as a SEM-based defect inspecting device that irradiates the entire surface of a sample with an electron beam to inspect the position and size of a defect, or a defect reviewing device that reviews a defect on the basis of defect information obtained from a higher-level defect inspecting device.

The design data is represented in, for example, GDS format or OASIS format, and stored in a predetermined form. The design data may be of any type as long as design-data display software can display the format and treat the format as graphics data. The storage medium 1306 may be included in a controller of any of the measuring device and inspecting devices, or in the condition setting device 1304 or the simulator 1305. The simulator 1305 has a function of simulating a position where a defect occurs (or a position of a defect candidate) on the basis of the design data.

The CD-SEM 1301, the defect inspecting device 1302, and the optical inspecting device 1303 have their respective controllers that perform control necessary for the respective devices. These controllers may have the above functions of the simulator and functions of setting the measuring conditions and the like.

In each SEM, an electron beam emitted from an electron source is converged by multiple-stage lenses. A scan deflector causes the converged electron beam to scan the sample one- or two-dimensionally.

Secondary electrons (SEs) or backscattered electrons (BSEs) released from the sample as a result of the scanning by the electron beam are detected by a detector and stored in a storage medium such as frame memory in synchronization with the scanning of the scan deflector. Image signals stored in the frame memory are multiplied by an operating unit provided in the controller. The scan deflector can scan in any range, position, and direction.

The above control is performed in the controller of each SEM, and images and signals resulting from the electron-beam scanning are sent to the condition setting device 1304 via the communication line network. Although the controllers that control the SEMs and the condition setting device 1304 are described as separate components in this example, this is not limiting. Rather, the condition setting device 1304 may perform both the device control and the measurement processes, or each controller may perform both the SEM control and the measurement processes.

The condition setting device 1304 or any of the controllers has stored therein a program for performing the measurement processes, and performs measurement or computation according to the program.

The condition setting device 1304 has a function of generating, on the basis of the semiconductor design data, a program (recipe) for controlling the operation of the SEMs, and serves as a recipe setting unit. Specifically, the condition setting device 1304 generates a program for setting positions for processes necessary for the SEMs, such as desired measurement points, autofocus points, automatic astigmatism correction points, and addressing points, on the design data, pattern contour data, or simulated design data, and for automatically controlling a sample stage, the deflector, etc., of the SEMs according to the settings.

FIG. 14 is a schematic block diagram of a scanning electron microscope. An electron beam 1403 extracted by an extracting electrode 1402 from an electron source 1401 and accelerated by an accelerating electrode (not shown) is concentrated by a condenser lens 1404, which is a type of convergence lens. A scan deflector 1405 then causes the electron beam 1403 to scan a sample 1409 one- or two-dimensionally. The electron beam 1403 is decelerated by negative voltage applied to an electrode provided in a sample stage 1408 while converged by a lens effect of an objective lens 1406 and emitted to the sample 1409.

When the sample 1409 is irradiated with the electron beam 1403, electrons 1410 such as secondary electrons and backscattered electrons are released from the irradiated position. The released electrons 1410 are accelerated toward the electron source by an acceleration effect based on negative voltage applied to the sample, and collide with a converting electrode 1412 to produce secondary electrons 1411. The secondary electrons 1411 ejected from the converting electrode 1412 are captured by a detector 1413. An output I of the detector 1413 changes with the amount of the captured secondary electrons, and the brightness of a display device (not shown) changes with the output I. For example, to form a two-dimensional image, a deflection signal to the scan deflector 1405 and the output I of the detector 1413 are synchronized with each other to form an image of a scanning area. The scanning electron microscope illustrated in FIG. 14 also includes a deflector (not shown) that shifts the scanning area of the electron beam. This deflector is used for purposes such as forming images of patterns of the same shape at different positions. This deflector, also called an image shift deflector, allows shifting the FOV (Field Of View) position of the electron microscope without moving the sample stage, i.e., the sample. In this example, this deflector is used for positioning the FOV in an area represented by a partial image to be provided for forming a synthesized image. The image shift deflector and the scan deflector may be integrated into a single deflector, so that a signal for image shifting and a signal for scanning may be superimposed and provided to the integrated deflector.

Although the example in FIG. 14 illustrates that the electrons released from the sample are once converted by the converting electrode and then detected, needless to say, this is not limiting. For example, an electron zoom image tube or a detection surface of a detector may be disposed on the path of the accelerated electrons.

A controller 1404 controls the components of the scanning electron microscope, and has a function of forming an image on the basis of the detected electrons and a function of measuring the pattern widths of patterns formed on the sample on the basis of an intensity distribution, called a line profile, of the detected electrons.

Rather than a large system as illustrated in FIG. 13, a measuring and inspecting system consisting of a measuring/inspecting device 401 and a computer 402 as illustrated in FIG. 4 may be employed. In the system illustrated in FIG. 4, the computer 402 includes a data operating unit such as a CPU and a data recording device for recording (which records reticle-pattern coordinate data corresponding to wafer-pattern defect coordinates detected in wafer inspection, reticle-pattern design data, parameters used for generating measurement information, and the measurement information obtained by a measurement information generation method to be described below). The data operating means performs software processes according to the information stored in the data recording device.

The computer 402 also includes a data I/F capable of transmitting, via means such as a network, a hard disk, or memory, the measurement information obtained by the measurement information generation method to be described below to the measuring/inspecting device 401, such as a CD-SEM, which performs reticle-pattern measurement.

The measurement information, which is necessary for reticle-pattern measurement, includes reticle coordinate information for measuring patterns and the directions in which the patterns are measured (e.g., the vertical direction and the horizontal direction). The following embodiments describe procedures of determining this measurement information from defect coordinates detected in wafer inspection, reticle-pattern design layout, and user-specified measurement parameters for reticle-pattern measurement.

Execution of measurement information generation and the user-specified measurement parameters to be illustrated in the following embodiments may be designated by a user using an input device provided in the condition setting device 1304 or using a data input device 404 connected to the computer 402. Further, the design layout and the measurement parameters used for generating the measurement information, and the measurement information determined in the measurement information generation, to be described in the following embodiments, may be provided to the user through a display device provided in the condition setting device 1304 or through data display means 403 connected to the computer 402.

### First Embodiment 1

FIG. 1 is a flowchart describing a general procedure of reticle pattern measurement on the basis of defect coordinate information identified with a defect inspecting device or a simulator. FIG. 2(a) shows a shot image of wafer patterns, and FIG. 2(b) shows a shot image of reticle patterns corresponding to the wafer patterns in FIG. 2(a). In current lithography techniques, patterning of reticle patterns involves projecting the reticle patterns of a reduced size on a wafer, so that the reticle patterns and the wafer patterns are actually different in size. In FIG. 2, the patterns are shown having the same sizes for ease of comparison.

As illustrated in FIG. 2, the wafer patterns and the reticle patterns are significantly different in shape because of various shape corrections applied to the reticle patterns for preventing distortion of the wafer patterns due to the optical proximity effect. FIG. 2(a) and (b) show defect coordinates 201 detected in wafer inspection and reticle-pattern coordinates 202 corresponding to the defect coordinates 201, respectively. Since the wafer patterns and the reticle patterns are different in shape for the above reason, it is difficult to determine a measurement position for measuring a position on the reticle patterns corresponding to the defect coordinates on the wafer patterns.

An interval (y) between edge patterns most proximate to the reticle-pattern coordinates 202 could be measured as illustrated in FIG. 2(b). However, the formation of a wafer pattern corresponding to that site may be influenced by the proximity effect due to shapes and arrangement of patterns surrounding the edge patterns. Accordingly, intervals (x) and (z) between proximate edge patterns, dimensions (u) and (v) of surrounding patterns, etc., are comprehensively measured and utilized for determination of the cause of the defect.

FIG. 3(a) is a diagram showing a reticle-pattern design layout corresponding to the reticle-pattern coordinates 202 in FIG. 2(b). FIG. 3(b) is an enlarged diagram including an area around reticle-pattern coordinates 301 shown in FIG. 3(a).

The method of generating the measurement information will be described in detail according to the flowchart illustrated in FIG. 1. First, wafer defect coordinates, or reticle-pattern coordinates corresponding to the wafer defect coordinates, resulting from wafer inspection or wafer manufacture simulation, are read from the data recording means of the computer 402, or from the storage medium 1306, or from a storage medium in the defect inspecting device 1302 or the optical inspecting device 1303 (step 101). If the wafer defect coordinates are read, the read defect coordinates are converted into the reticle-pattern coordinates corresponding to the defect coordinates.

A reticle design layout containing the reticle-pattern coordinate position is then read (102). The reticle design layout is design data in which pattern shapes are defined in a format such as GDS or OASIS. Since the design layout for the entire surface of the reticle involves a large amount of data, in order to simplify processing, a design layout of a certain area containing proximate patterns around the reticle-pattern coordinates 301 may be extracted and read from the design data as in FIG. 3(b), for example. The certain area is preferably defined to surround the area of patterns that have the optical proximity effect on the reticle-pattern coordinate position.

In this embodiment, pattern shapes are analyzed in a two-dimensional area defined on the layout data as above (an area containing at least two patterns, or an area containing even one pattern having a plurality of vertex angles and capable of measuring intervals between collinear points on edges (contour)). Then, measurement positions are set at appropriate positions. The following description illustrates a detailed example of this.

The pattern shapes on the design layout are then analyzed for comprehensively measuring the intervals and dimensions of patterns proximate to the reticle-pattern coordinates (step 103).

A procedure of analyzing the pattern shapes will be described with reference to a flowchart illustrated in FIG. 5. First, patterns included in the design layout are graphically rendered (step 501). Since the design layout data includes information for identifying each pattern and the inside and outside of each pattern (corresponding to a pattern hollow and a remaining portion), the patterns are rendered so that the two types of identification information are reflected in the brightness values of the patterns.

For example, as in FIG. 3(b), areas outside the patterns are rendered white (the maximum brightness value). The inside of the patterns such as reticle patterns 303 to 306 in FIG. 3(b) are rendered with varying brightness values according to the pattern identification information so that the patterns are distinguishable from each other with reference to the brightness values. More specifically, in order to attach identification information to the patterns and the background to allow distinction among these portions, the background (where no patterns exist) is assigned the maximum brightness, and each pattern is assigned different brightness. For example, where three patterns A, B, and C exist, the patterns A, B, and C are assigned the brightness A, B, and C, respectively. It is to be noted that the background may be assigned brightness other than the maximum brightness.

A mesh 307 is then set on the design-pattern rendering image as in FIG. 3(b) (step 502). All intersections (e.g., an intersection 308) of mesh lines and the design patterns are determined (step 503). All sets of two intersections on the same mesh line (e.g., intersections 308 and 309, intersections 308 and 310, and intersections 311 and 312) are determined for vertical lines and horizontal lines (step 504). Pattern intervals corresponding to the determined intersection sets are targets of the reticle-pattern measurement.

For each intersection set, the interval between the intersection closer to the reticle-pattern coordinates and the reticle-pattern coordinates is measured (step 505). The value of this interval is used for determining the measurement method to be described below.

Pattern geometry indicated by each intersection set (the interval between points on different patterns, or the interval between points on the same pattern (outside the pattern or inside the pattern)) is identified (step 506).

A specific example will be described for the intersection sets A (308, 309), B (308, 310), and C (311, 312) shown in FIG. 3(b). It is assumed that the intersections are located inside the patterns. First, the brightness values of patterns containing the intersections are referred to. The intersections in the set A have different brightness values. The intersections in each of the sets B and C have the same brightness value. This is because the intersections in the set A are in different patterns, and the intersections in each of the sets B and C are in the same pattern. In this manner, comparing the brightness values of patterns containing the elements of an intersection set allows readily determining whether the intersection set indicates an interval between points on different patterns or an interval between points on the same pattern.

For an interval between points on the same pattern such as the intervals of the intersection sets B and C, the pattern geometry can be identified in more detail. Specifically, the intersection set may indicate a pattern interval inside the same pattern as with the intersection set B, or a pattern interval outside the same pattern as with the intersection set C. The pattern geometry of such an intersection set can be identified by referring to the brightness value in a graphical area between the intersections. For an intersection set indicating a pattern interval inside the same pattern, the brightness value in a graphical area between the intersections is equal to the brightness value at the intersections. For an intersection set indicating a pattern interval outside the same pattern, the brightness value in a graphical area between the intersections is the brightness value of the non-pattern portion and therefore different from the brightness value at the intersections.

Thus, the pattern geometry (the interval between points on different patterns, or the interval between points on the same pattern (outside the pattern or inside the pattern)) indicated by an intersection set can be identified by comparing the brightness values at the intersections in the set and comparing the brightness value in a graphical area between the intersections in the set and the brightness value at the intersections.

The mesh lines may be arranged vertically and horizontally at regular intervals as in FIG. 2(b), or the mesh density may be adjusted to allow more detailed pattern measurement for patterns closer to a reticle-pattern coordinates 701 as in FIG. 7(a). Alternatively, as in FIG. 7(b), the mesh shown in FIG. 2(b) or 7(a) may be rotated and applied to the design layout to obtain intersection sets for pattern measurement in oblique directions.

The intervals between mesh pattern lines shorter in a center area and longer in peripheral areas allow the measurement to be focused on the area around the defect, which is likely to contribute to the occurrence of the defect.

The mesh is desirably set in the direction perpendicular to the continuous direction of the design layout patterns. For this purpose, the angle of rotation may be determined in such a manner that the direction of the patterns contained in the design layout is determined and mesh lines are set in the direction perpendicular to the determined direction.

Coordinate transformation is then performed (step 507). Since the intersection coordinates and distance values determined as above are based on the coordinate system on the graphics, the coordinate values on the graphics are transformed into reticle-pattern coordinates with reference to a pixel scale (one pixel=L nm) used for the graphical rendering of the patterns. If a coordinate transformation error occurs, the error value may be taken into account to correct transformed coordinate positions to pattern positions on the design layout.

The result of the above analysis of the shapes of proximate patterns is used to determine the reticle-pattern measurement information (step 104). Specifically, the result of the analysis of the shapes of proximate patterns is compared with measurement parameters specified by the user through the data input device 404 to determine the measurement information. Examples of the result of the analysis of the shapes of proximate patterns and the user-specified measurement parameters include the following.

Examples of the result of the analysis of the shapes of proximate patterns may include: the coordinates of the intersection sets (the intersection sets on the vertical lines and/or the horizontal lines of the mesh); the pattern geometry (the interval between points on different patterns, or the interval between a measurement start point and an end point of the same pattern (e.g., a pattern overlapping the defect coordinates), where the measurement start point and/or end point are on the contour of the same pattern (outside the pattern and/or inside the pattern)); and the interval between the reticle-pattern coordinates and each intersection proximate to the reticle-pattern coordinates. Example of the user- or operator -specified measurement parameters may include: the pattern measurement area around the reticle-pattern coordinates, the geometry of the pattern to be measured (the interval between points on different patterns, or the interval between a measurement start point and an end point of the same pattern (e.g., a pattern overlapping the defect coordinates), where the measurement start point and/or end point are on the contour of the same pattern (outside the pattern or inside the pattern)); the measurement directions (e.g., the horizontal direction and the vertical direction); and the magnification at which the reticle patterns are shot.

A procedure of determining the measurement information will be described in detail below. First, if conditions such as the reticle pattern measurement area, the geometry of the pattern to be measured, and the measurement directions are specified by the user, the result of the proximate pattern analysis is narrowed down to coordinate sets that match the specified conditions. The coordinates of intersection positions of all intersection sets resulting from the narrowing down according to the user specification are set as measurement coordinates.

The measurement directions are determined according to the mesh line directions. That is, for a coordinate set determined for a vertical line of the mesh, the interval between pattern points corresponding to the intersection positions of the intersection set is measured in the vertical direction. For a coordinate set determined for a horizontal line of the mesh, the interval between pattern points corresponding to the intersection positions of the intersection set is measured in the horizontal direction.

The measurement information (the measurement coordinates and the measurement directions) determined through the above procedure is written to the data recording means of the computer 402 (step 105).

According to the above technique, from information on reticle coordinates corresponding to defect coordinates on a wafer detected in inspection of the wafer or of a transferred image on the wafer and from information on a reticle design layout containing the reticle coordinates, it is possible to determine measurement information for measuring a pattern that has a reticle pattern edge most proximate to the reticle coordinates and measurement information for measuring a pattern that is in a predetermined area containing the reticle coordinates and that does not have the most proximate reticle pattern edge. This allows automatically generating measurement information for comprehensively measuring reticle patterns that may have an influence at the time of producing a pattern determined as defective on the wafer.

### Second Embodiment

FIG. 9 is a flowchart describing a procedure of generating a recipe for controlling SEM operation on the basis of coordinate information and performing measurement according to the generated recipe. The flowchart shows a procedure in which the measurement information described in the first embodiment is used to perform the reticle-pattern measurement, and the measurement result is written to the data recording means of the computer 402, the storage medium in the condition setting device 1304, or the like. Steps 101 to 105 up to determining the measurement information have been described in the first embodiment and therefore will not be described again.

After determining the measurement information, a measurement recipe for measuring the reticle pattern with a reticle inspecting device such as a CD-SEM is generated (step 901). The measurement recipe is data for controlling the reticle inspecting device, and it is data having registered therein information for shooting reticle patterns to be measured with imaging means such as an optical microscope or a SEM and for measuring target patterns.

Generally, information registered in the measurement recipe includes: information on measurement points for the reticle patterns to be measured; pattern measurement directions (e.g., the vertical direction and the horizontal direction); information on image shooting positions for the reticle patterns; a template for determining measurement points from a shot image using pattern matching; a point for adjusting the focus of the image; and image shooting conditions (such as the shooting magnification, and, if a SEM is used to shoot the reticle patterns, conditions such as the acceleration voltage and the probe current value of the SEM).

The above information registered in the measurement recipe is determined on the basis of the information on the reticle-pattern measurement coordinates and measurement directions determined by the above-described measurement information generation method. A specific example of this will be described below. It is to be noted that the image shooting conditions are generally determined according to the user's specification or device-recommended values, and the focus point and the template used for pattern matching are determined by an established automatic or manual method based on the reticle-pattern measurement coordinates. These information items will therefore not be described.

A method of determining image shooting positions will be described with reference to a flowchart shown in FIG. 6. Generally, as the image shooting magnification is higher, the resolution of the image can be increased as long as the device performance limit is not reached, and therefore the accuracy of pattern measurement is increased. For this reason, inspection is usually performed by setting a high image shooting magnification. Increasing the image shooting magnification causes the size of the field of view of an image to be reduced correspondingly. Then, a situation may occur such that the whole group of intersection sets to be measured, determined as the measurement information, does not fall within the field of view of one image. As such, image shooting positions are determined by dividing an image shooting area so that the coordinates of every intersection set to be measured fall within any one of a plurality of images.

First, among all the intersection sets determined by the design layout analysis, coordinate positions of all intersection sets within a user-specified area or within the range in which the reticle-pattern coordinates are subjected to the optical proximity effect are referred to (step 601).

The size of the range of the field of view of the image is determined from the image shooting magnification, and it is determined whether all the intersection sets are inside the range of the field of view (step 602). If any intersection set is outside the field of view, a new image shooting area is added such that the intersection set is included in the range of the field of view (step 604). Finally, the center coordinates of each image shooting area are determined as the image shooting point (step 605).

An example of dividing the image shooting area will be described with reference to a design layout in FIG. 8. An area 801 covering all the intersection sets to be measured is determined, and a plurality of image shooting areas 802 are determined according to comparison of the field-of-view ranges based on the image shooting magnification so that all intersection sets can be measured.

Now, a method of determining the reticle-pattern measurement point information will be described with reference to FIG. 10. Basically, a midpoint position 1003 between coordinates 1002 of an intersection set is taken as the coordinates of a measurement point, and measurement positions on patterns corresponding to this measurement point are the coordinates 1002 of the two intersections of the set. However, since the coordinates 1002 of the intersection set are the coordinate positions determined in the design layout analysis, the patterns to be measured may not be able to be determined in the shot image if the actual reticle-pattern shapes are distorted with respect to the design-layout patterns. For this reason, pattern edge search areas 1001 centered on the respective coordinates 1002 of the intersection set and not including the opposite intersection coordinates are defined. The information on the coordinates of the measurement points, the positions of the patterns to be measured, and the pattern edge search areas is determined for all the intersection sets and registered as the measurement point information in the measurement recipe.

On the basis of the measurement recipe generated through the above procedure, the reticle patterns are shot and measured (step 902). Finally, the result of the pattern measurement based on the measurement recipe is stored in the data storage means (step 903).

The measurement result is also displayed on the data display means 403 connected to the computer 402. For example, graphics in which values are superimposed on the design layout as in FIG. 11(b) may be generated and displayed on the data display means 403 to provide the measurement result to the user. If numerous measured values are obtained and numerical display would reduce the visibility, FIGS. 1101 to 1103 such as circular or rectangular patterns may be set at the midpoints of the measured intersection sets as in FIG. 11(b). Then, color information on each figure may be determined on the basis of the pattern geometry identification information described in the first embodiment (the interval between points on different patterns, or the interval between points on the same pattern (outside the pattern or inside the pattern)) and on the basis of the measured value, or the difference between the measured value and an ideal value.

For example, a typical color monitor used as the data display means 403 provides full-color display by combining color information of three colors of R, G and B, each varied in 256 levels. Accordingly, for example, graphics may be generated and displayed on the data display means 403 such that an interval between points on different patterns is set to R (1101), an interval between points on the same pattern (outside the pattern) is set to G (1102), and an interval between points on the same pattern (inside the pattern) is set to B (1103), where each brightness value represents a measured value or the difference between a measured value and an ideal value. This allows providing the measurement result to the user without reducing the visibility even when numerous measured values are obtained.

Thus, from information on reticle coordinates corresponding to defect coordinates on a wafer detected in inspection of the wafer or of a transferred image on the wafer and from information on a reticle design layout containing the reticle coordinates, it is possible to determine measurement information for measuring a pattern that has a reticle pattern edge most proximate to the reticle coordinates and measurement information for measuring a pattern that is in a predetermined area containing the reticle coordinates and that does not have the most proximate reticle pattern edge. Further, a measurement recipe is generated using the measurement information, and measurement is performed and the user is provided with the measurement result. This allows efficiently providing user with information that can be utilized for determining the cause of the defect in a wafer pattern due to a reticle pattern.

A technique of extracting the intersection sets will be described in more detail with reference to a superimposed display image of a mesh image and layout data illustrated in FIG. 12. FIG. 12 is a diagram describing an example in which layout data is superimposed on a mesh 1201. It is assumed that a defect coordinates 1202 are read from a device such as a defect inspecting device in advance. Four patterns (patterns 1203 to 1206) are displayed with respective different brightness values in the superimposed image.

By extracting intersection sets from the superimposed image, 13 vertical intersection sets outside a pattern and 5 horizontal intersection sets outside a pattern can be detected. Similarly, 7 vertical intersection sets inside a pattern and 11 horizontal intersection sets inside a pattern can be detected. In FIG. 12, for ease of understanding, each intersection set inside a pattern is represented by a dotted line with black circles at the start point and the end point, and each intersection set outside a pattern is represented by a solid line with arrows at the start point and the end point.

On the above preconditions, a technique of analyzing the shapes of proximate patterns and determining pattern measuring conditions on the basis of the analysis will be described below. The cause of a defect may be present not only where the defect actually occurs but also at a pattern near the defect (an adjacent pattern or a pattern at a distance of the order of μm from where the defect occurs). Therefore, the inside of a pattern in question (or the outside of the pattern if a foreign substance or the like exists outside the pattern) and the outside of the pattern (or the inside of the pattern) are both taken as evaluation targets. Further, for efficient measurement, measurement positions are selected according to the following criteria.

First, in order to select measurement candidates inside the pattern, intersection sets that are within an area having the same brightness as the defect coordinates and that are on a mesh line within a predetermined number of mesh lines from the defect coordinates. In this example, the predetermined number is preset to one for both the vertical lines and the horizontal lines, so that intersection sets 1211 to 1214 that are on lines 1207 to 1210 and that have the same brightness information as the defect coordinates are selected. Then, in order to select measurement candidates outside the pattern, intersection sets adjacent to the above selected intersection sets inside the pattern are selected among intersection sets that are outside the pattern (the area with the maximum brightness) and that are on a line within the predetermined number of lines. In this example, these are intersection sets 1215 to 1221. The intersection set 1215 is a set of an intersection on the contour of the pattern containing the defect and an intersection at a different position on the same contour. The intersection sets 1216 to 1221 are each a set of an intersection on the contour of the pattern containing the defect and an intersection on the contour of another pattern.

The intersection sets 1211 to 1214 (first measurement positions) and 1215 to 1221 (second measurement positions) selected as above are taken as measurement candidates.

Thus, different information (brightness information) is assigned to each area partitioned with lines indicating the contours of the patterns. Intersections of the contours and the mesh-like grid reference lines are extracted, and measurement positions between the extracted intersections are selected according to the information on each area. According to this technique, sites that may have an influence on the defect can be selectively extracted as measurement candidates on the basis of the coordinate information on the defect. This allows a significant reduction in the effort of setting the measuring conditions.

Particularly, since the attribute information is assigned to each area (the inside or outside of the patterns, and each of the patterns), line segments can be identified even on the same line according to the attribute information. As a result, measurement points can be set on an area basis.

In the technique illustrated in FIG. 12, the intersection sets on lines within the predetermined number of lines from the defect coordinates are extracted. However, this is not limiting. For example, intersection sets on lines within a predetermined distance from the defect coordinates may be extracted, or intersection sets on lines overlapping a certain pattern may be selected. Besides the distance, the number of pixels or the number of pattern vertex angles may be used to determine line segments to be extracted. The measurement positions taken as the measurement candidates may be user-customizable to allow setting of measuring conditions that are more preferred by the user.

In order to allow setting from different perspectives, the number of intersection sets with reference to the defect coordinates may be settable. For example, for the line 1208, the intersection set 1212 closest to the defect coordinates corresponds to the first intersection set with respect to the defect coordinates. The intersection sets 1215 and 1217 correspond to the second intersection sets with respect to the defect coordinates. By allowing the ordering of the defect coordinates around the defect coordinates in this manner, the measurement positions can be appropriately assigned even for a pattern of a complex shape. As mentioned above, the cause of a defect may be present not only where the defect actually occurs but also at a pattern near the defect. Therefore, this technique is very effective in that the measurement positions can be readily set at the position where the defect occurs, as well as at other positions.

According to the above technique, the measurement positions can be set at appropriate positions on the basis of the defect coordinate information, the attribute information on the areas assigned on the layout data, and the operator's setting information.

FIG. 15 is a diagram describing an exemplary GUI (Graphical User Interface) screen for setting the measuring conditions. This screen is displayed on the display device provided in the computer 402 or the condition setting device 1304. Information on a defect read from a device such as an external defect inspecting device is stored in a storage medium in a device such as the computer 402 and is selectable by specifying “Defect Name.” The name and type of a pattern corresponding to the defect coordinates are displayed in the fields “Pattern Name” and “Pattern Type,” respectively, on the basis of layout data (design data) read along with the defect information. “Defect Location” displays coordinate information on the read defect. “Mesh Type” allows selecting a mesh pattern serving as reference lines for measurement positions. For example, a mesh as illustrated in FIG. 3 or 7 is selectable, and the selection state is displayed in a layout data display frame on the right side in FIG. 15. “Distance” is an input window for setting an arbitrary interval between mesh lines.

“Range Definition” is for setting a criterion for determining a measurement range around the defect coordinates. For example, if “Number of Lines” is selected to set the number of lines, intersection sets on pattern contours are extracted for the set number of lines. Similarly, if “Width” or “Pixels” is selected, intersection sets are extracted for lines within the set width or the set number of pixels around the defect coordinates. If a specific pattern is entered in “Pattern,” lines relevant to the selected pattern (e.g., lines intersecting the selected pattern) are set.

Measurement positions determined according to the above condition settings are displayed in “Measurement Positions” and in the layout data display frame. The user can suitably customize the measurement positions by adjusting the measurement positions in the conditions in “Measurement Positions” or in the layout data display frame using a pointing device or the like. Pressing a “Learn” button causes the entered settings to be registered as an operation recipe of the CD-SEM. At this point, the FOV may be automatically selected to include the measurement targets.

Thus, in accordance with this embodiment, measurement candidate positions can be appropriately set for patterns that may be modified due to the optical proximity effect or the like. This allows a significant reduction in the setting load on the operator.

According to the above technique, from information on reticle coordinates corresponding to defect coordinates on a wafer detected in inspection of the wafer or of a transferred image on the wafer and from information on a reticle design layout containing the reticle coordinates, it is possible to determine measurement information for measuring a pattern that has a reticle pattern edge most proximate to the reticle coordinates and measurement information for measuring a pattern that is in a predetermined area containing the reticle coordinates and that does not have the most proximate reticle pattern edge. This allows automatically generating the measurement information for comprehensively measuring reticle patterns that may have an influence at the time of producing a pattern determined as a defect on the wafer.

### REFERENCE SIGNS LIST

201 defect coordinates

202, 301, 701 reticle-pattern coordinates

303 to 306 reticle pattern

307 mesh

308 to 312 intersection

401 measuring/inspecting device

402 computer

403 data display means

404 data input device

801 area

802 image shooting area

1001 pattern edge search area

1002 intersection set coordinates

1003 midpoint position

1101 to 1103 figure at the midpoint of an intersection set

1. A pattern measuring condition setting device for setting pattern measurement positions on the basis of defect coordinates, characterized by comprising
an operating unit that superimposes reference lines including a plurality of line segments on a two-dimensional area on layout data, and sets a first measurement position that is inside a contour indicating a pattern containing the defect coordinates and that is between intersections of the contour and a reference line, and a second measurement position that is outside the contour and that is between intersections of the contour and a reference line or between an intersection of the contour and a reference line and an intersection of another contour and the reference line.

2. The pattern measuring condition setting device according to claim 1, characterized in that the layout data comprises identification information about a plurality of patterns arranged on a sample.

3. The pattern measuring condition setting device according to claim 1, characterized in that the layout data comprises reticle-pattern layout information.

4. The pattern measuring condition setting device according to claim 1, characterized in that the operating unit selects the first measurement position and the second measurement position on the line segments within a predetermined area defined with reference to the defect coordinates.

5. The pattern measuring condition setting device according to claim 1, characterized in that the reference lines form a grid pattern.

6. The pattern measuring condition setting device according to claim 5, characterized in that the grid pattern is rotatably superimposed on the layout data.

7. The pattern measuring condition setting device according to claim 5, characterized in that intervals between grid lines of the grid pattern are shorter in a center portion of the grid pattern than in a periphery portion of the grid pattern.

8. The pattern measuring condition setting device according to claim 1, characterized in that the operating unit narrows down the first measurement position and the second measurement position using information provided through an input device for inputting a measurement condition.

9. A computer program causing a computer to set measuring conditions for a semiconductor device, the computer comprising or being capable of accessing a storage medium having stored therein design data about the semiconductor device,
the computer program being characterized by causing the computer to superimpose reference lines including a plurality of line segments on a two-dimensional area on layout data, and set a first measurement position that is inside a contour indicating a pattern containing defect coordinates and that is between intersections of the contour and a reference line, and a second measurement position that is outside the contour and that is between intersections of the contour and a reference line or between an intersection of the contour and a reference line and an intersection of another contour and the reference line.

10. The computer program according to claim 9, characterized in that the layout data comprises identification information about a plurality of patterns arranged on a sample.

11. The computer program according to claim 9, characterized in that the layout data comprises reticle-pattern layout information.

12. The computer program according to claim 9, characterized by causing the computer to select the first measurement position and the second measurement position on the line segments within a predetermined area defined with reference to the defect coordinates.

13. The computer program according to claim 9, characterized in that the reference lines form a grid pattern.

14. The computer program according to claim 13, characterized in that the grid pattern is rotatably superimposed on the layout data.

15. The computer program according to claim 13, characterized in that intervals between grid lines of the grid pattern are shorter in a center portion of the grid pattern than in a periphery portion of the grid pattern.

16. The computer program according to claim 9, characterized in that an operating unit narrows down the first measurement position and the second measurement position using information provided through an input device for inputting a measurement condition.

17. A measuring system comprising: a defect inspecting device that detects a defect position on a sample and/or a simulation device that simulates the defect position on the basis of semiconductor device design data; and a pattern measuring device that measures patterns on a reticle according to a recipe generated on the basis of defect position information detected by the defect inspecting device or the simulation device,
the measuring system being characterized by comprising an operating unit that superimposes reference lines including a plurality of line segments on a two-dimensional area on layout data, and sets a first measurement position that is inside a contour indicating a pattern containing defect coordinates and that is between intersections of the contour and a reference line, and a second measurement position that is outside the contour and that is between intersections of the contour and a reference line or between an intersection of the contour and a reference line and an intersection of another contour and the reference line.
